(19) United States
(12) Patent Application Publication
(10) Pub. No.: US 2015/0297923 A1
(43) Pub. Date: Oct. 22, 2015

(54) FIRE-RETARDING APPARATUS AND METHODS OF THEIR MANUFACTURE

(71) Applicant: The Boeing Company, Chicago, IL (US)

(72) Inventor: Sham S. Hariram, Seattle, WA (US)

(21) Appl. No.: 14/523,741

(22) Filed: Oct. 24, 2014

Related U.S. Application Data
(63) Continuation-in-part of application No. 14/021,690, filed on Sep. 9, 2013.
Application No. 14/021,690 is a continuation-in-part of application No. 14/021,542, filed on Sep. 9, 2013.

(51) Int. Cl. A62C 3/08; B32B 15/04; B32B 37/10; B32B 9/04; B32B 37/18; B32B 37/12; A62C 3/07; B32B 27/06

(52) U.S. Cl. CPC A62C 3/08; A62C 3/07; B32B 15/04; B32B 27/06; B32B 9/04; B32B 37/18; B32B 37/12; B32B 37/10; B32B 2307/3065; B32B 2605/08; B32B 2605/18; B32B 2307/718

(57) ABSTRACT

A fire-retarding apparatus includes a composite. The composite includes a face layer attached to a fire-retarding layer.

### CROSS-REFERENCE TO RELATED APPLICATIONS

This application is a continuation-in-part application of U.S. patent application Ser. No. 14/021,690 filed on Sep. 9, 2013 and entitled Fire-Retaining Containers, and is also a continuation-in-part application of U.S. patent application Ser. No. 14/021,542 filed on Sep. 9, 2013 and entitled Containers For Fire Containment.

### FIELD OF THE DISCLOSURE

This disclosure relates to fire-retarding apparatus comprising composites and to their methods of manufacture.

### BACKGROUND

It is sometimes needed to make apparatus fire-retarding. This is often done using heavy metal construction using materials such as Steel, Titanium, Inconel, and other materials. However, use of such materials increases weight and expense. This is an important issue in the aircraft industry where weight and cost reduction is needed.

A fire-retarding apparatus and method of manufacture is needed to resolve one or more issues of one or more current fire-retarding apparatus or methods of manufacture.

### SUMMARY

In one embodiment, a fire-retarding apparatus is disclosed. The fire-retarding apparatus includes a composite. The composite includes a face layer attached to a fire-retarding layer.

In another embodiment, a fire-retarding apparatus is disclosed. The fire-retarding apparatus includes a composite. The composite includes a face layer, a fire-retarding layer, a fire-retarding attachment member or fire-retarding attachment layer attaching the face layer to the fire-retarding layer, and a reinforcing layer attached to the fire-retarding layer or reinforcing material embedded in the fire-retarding layer.

In still another embodiment, a method of manufacturing a fire-retarding apparatus is disclosed. A fire-retarding layer is attached to a face layer to form a composite.

The scope of the present disclosure is defined solely by the appended claims and is not affected by the statements within this summary.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure.

FIG. 1 illustrates a perspective view of a fire-retarding apparatus;

FIG. 2 illustrates a cross-section view through line 2-2 of the fire-retarding apparatus of FIG. 1;

FIG. 3 illustrates another embodiment of a cross-section view through line 2-2 in the fire-retarding apparatus of FIG. 1;

FIG. 4 illustrates still another embodiment of a cross-section view through line 2-2 in the fire-retarding apparatus of FIG. 1;

FIG. 5 illustrates yet another embodiment of a cross-section view through line 2-2 in the fire-retarding apparatus of FIG. 1; and

FIG. 6 is a flowchart illustrating one embodiment of a method of manufacturing a fire-retarding apparatus comprising a composite.

### DETAILED DESCRIPTION

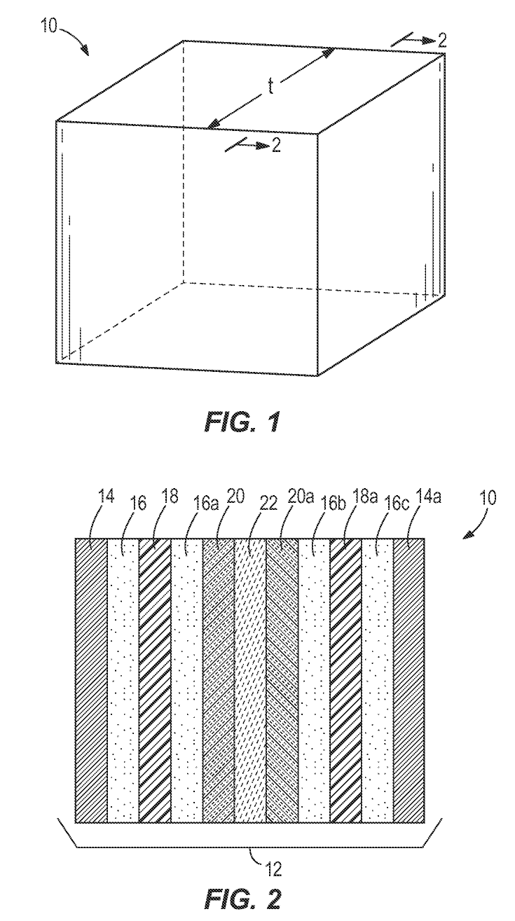

FIG. 1 illustrates a perspective view of a fire-retarding apparatus 10. The fire-retarding apparatus 10 may comprise a portion of an aircraft, a portion of a spacecraft, a portion of a vehicle, or another type of apparatus for which it is desired to be fire-retarding. For instance, in an aircraft, the fire-retarding apparatus 10 may comprise any portion of the aircraft which needs to be made fire-retarding such as the engine cowling, a nacelle which holds the engine, a cargo compartment, a housing which holds an airplane component, a skin of the aircraft, a fuselage, or another portion of the aircraft. In other embodiments, the fire-retarding apparatus 10 may further vary. The fire-retarding apparatus 10 may weigh less than 100 pounds per square foot, and may have a thickness t (shown in FIG. 2) of less than 3 feet. In other embodiments, the fire-retarding apparatus 10 may weigh less than 1 pound per square foot, and may have a thickness t (shown in FIG. 2) of less than 8 inches. In still other embodiments, the weight and thickness of the fire-retarding apparatus 10 may vary further.

FIG. 2 illustrates a cross-section view through line 2-2 of the fire-retarding apparatus 10 of FIG. 1. The fire-retarding apparatus 10 may comprise a composite 12. The composite 12 may comprise the following attached layers: face layer 14; fire-retarding attachment layer 16; reinforcing layer 18; fire-retarding attachment layer 16a; fluid-repelling layer 20; fire-retarding layer 22; fluid-repelling layer 20a; fire-retarding attachment layer 16b; reinforcing layer 18a; fire-retarding attachment layer 16c; and face layer 14a. In other embodiments, any of the layers may vary in order or number, one or more of the layers may not be present, or one or more additional layers may be used. In still other embodiments, the fire-retarding apparatus 10 may consist of any combination of the layers including all of the layers or taking away one or more of the layers.

The face layers 14 and 14a may comprise non-fire-retarding layers. The face layers may comprise sheets of aluminum, composite, metal, non-metallic, polyimide, fluid repelling, or another type of material. In other embodiments, the face layers 14 and 14a may be made of any type of non-fire-retarding or fire-retarding material.

The fire-retarding attachment layers 16, 16a, 16b, and 16c may be used to adhere the layers disposed on opposite sides of them together, using a material which is fire-retarding. For purposes of this disclosure, the term “fire-retarding” means that the layer or member is made of a material which retards fire, or which doesn't ignite or contains the fire, which prevents the fire from spreading or penetrating through, and which either suppresses the fire or extinguishes it through containment and/or lack of oxygen. The fire-retarding attachment layers 16, 16a, 16b, and 16c may comprise an adhesive, paste, solid, or another adhering material which is fire-retarding. The fire-retarding attachment layers 16, 16a, 16b, and 16c may be made of ceramic, metal, non-metallic, composite, Aramid, aerogel, or polyimide. In other embodiments, the fire-retarding attachment layers 16, 16a, 16b, and 16c may be made of varying materials which both adhere the layers disposed on opposite sides of them together, and are fire-retarding having fire retarding properties equivalent to Underwriter Laboratories (UL) Rating of UL-94 V-0 (does not burn) with an operating temperature range of −452 degrees F. to 3,600 degrees F. In additional embodiments, the fire-retarding attachment layers 16, 16a, 16b, and 16c may survive a fire of 2,000 degrees Fahrenheit minimum for 15 minutes without burning through and without burning the back or front sides. In still other embodiments, the fire-retarding attachment layers 16, 16a, 16b, and 16c may vary further. In one embodiment, the fire-retarding attachment layers 16, 16a, 16b, and 16c may comprise one or more fire-retarding attachment members which are used to attach layers. The fire-retarding attachment members may comprise fire-retarding fasteners, fire-retarding clamps, fire-retarding securement members, or other types of fire-retarding attachment members. In other embodiments, any of the layers of the fire-retarding apparatus 10 may be attached to one another through/using pressing, adhesives, tape, threads, screws, bolts, fasteners, rivets, staples, clamps, other mechanical members, or other attachment mechanisms.

The reinforcing layers 18 and 18a provide reinforcement and strength to the fire-retarding layer 22 to reduce the likelihood of the fire-retarding layer 22 tearing or disintegrating. The reinforcing layers 18 and 18a may be made of metal, non-metallic, ceramic, glass, composite, rubber, foam, Aramid, solid, fibrous material, or porous material. In other embodiments, the reinforcing layers 18 and 18a may be made of varying materials. In one embodiment, the reinforcing layers 18 and 18a have a fiber density of 1.0 to 5 gm/cm³, a fiber diameter of 3 to 20 micron (um), and a fiber tensile strength of 1.0 to 6.0 Gpa (Gigapascal) to provide strength. In other embodiments, the reinforcing layers 18 and 18a may be made of varying materials which provide strength and reinforcement. In other embodiments, instead of using separate reinforcing layers, reinforcing material may be embedded into the fire-retarding layer 22 to provide reinforcement and strength to the fire-retarding layer 22. The reinforcing material may comprise metal, non-metallic, ceramic, glass, composite, foam, rubber, or Aramid. In other embodiments, the reinforcing material may vary. Throughout this disclosure, any time the term “reinforcing” is used or a reference is made to reinforcement properties, the disclosure of this paragraph applies to the term.

The fluid-repelling layers 20 and 20a may provide fluid-repelling properties to reduce the likelihood of degradation of the fire-retarding layer 22 and prevent fluid absorption. For purposes of this disclosure, the term “fluid-repelling” is defined as preventing fluid from being absorbed by the base material. The fluid-repelling layers 20 and 20a may comprise silicone, a nano-coating, or another type of fluid-repelling material, coating, or spray. In one embodiment, the fluid-repelling layers 20 and 20a have a fluid repellency requirement to fluid proof test equivalent to or better than ASTM D-3393 (2009). In other embodiments, the fluid-repelling layers 20 and 2a may have varying fluid repellency. Throughout this disclosure, any time the term “fluid-repelling” is used or a reference is made to fluid-repelling properties, the disclosure of this paragraph applies to the term.

The fire-retarding layer 22 comprises a material which retards fire, which doesn't ignite and contains the fire, which prevents the fire from spreading or burning through, and which either suppresses the fire or extinguishes it through containment and/or lack of oxygen. The fire-retarding layer 22 may be made of metal, non-metallic, composite, ceramic, aerogel (organic and inorganic), xerogel (organic and inorganic), polyimide, (4,4-Oxydiphenylene-Pyromellitmide), mineral wool, ceramic paste, ceramic coating, or an inorganic material. In other embodiments, the fire-retarding layer 22 may be made of varying materials, such as a high-temperature paste which is applied and cured, which have fire retarding properties equivalent to Underwriter Laboratories (UL) Rating of UL-94 V-0 (does not burn) and an operating temperature range between −100 degrees F. to 3,600 degrees F. In additional embodiments, the fire-retarding layer 22 may survive a fire of 2,000 degrees Fahrenheit minimum for 15 minutes without burning through and without burning the back or front sides. In still other embodiments, the fire-retarding attachment layer 22 may vary further.

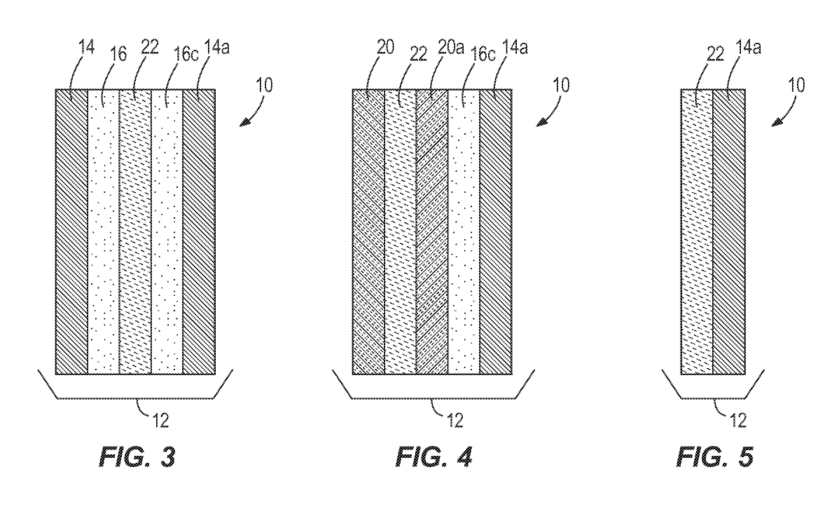

FIG. 3 illustrates another embodiment of a cross-section view through line 2-2 in the fire-retarding apparatus 10 of FIG. 1. As shown, in this embodiment the fire-retarding apparatus 10 comprises a composite 12 which includes the following attached layers: face layer 14; fire-retarding attachment layer 16; fire-retarding layer 22; fire-retarding attachment layer 16c; and face layer 14a. Reinforcing layer 18, fire-retarding attachment layer 16a, fluid-repelling layer 20, fluid-repelling layer 20a, fire-retarding attachment layer 16b, and reinforcing layer 18a have been eliminated from the cross-sectional embodiment of FIG. 2. In other embodiments, any of the layers may vary in order or number, one or more of the layers may not be present, or one or more additional layers may be used. In still other embodiments, the fire-retarding apparatus 10 may consist of any combination of the layers including all of the layers or taking away one or more of the layers.

FIG. 4 illustrates still another embodiment of a cross-section view through line 2-2 in the fire-retarding apparatus 10 of FIG. 1. As shown, in this embodiment the fire-retarding apparatus 10 comprises a composite 12 which includes the following attached layers: fluid-repelling layer 20; fire-retarding layer 22; fluid-repelling layer 20a; fire-retarding attachment layer 16c; and face layer 14a. Face layer 14, fire-retarding attachment layer 16, reinforcing layer 18, fire-retarding attachment layer 16a, fire-retarding attachment layer 16b, and reinforcing layer 18a have been eliminated from the cross-sectional embodiment of FIG. 2. In other embodiments, any of the layers may vary in order or number, one or more of the layers may not be present, or one or more additional layers may be used. In still other embodiments, the fire-retarding apparatus 10 may consist of any combination of the layers including all of the layers or taking away one or more of the layers.

FIG. 5 illustrates yet another embodiment of a cross-section view through line 2-2 in the fire-retarding apparatus 10 of FIG. 1. As shown, in this embodiment the fire-retarding apparatus 10 comprises a composite 12 which includes the following attached layers: fire-retarding layer 22; and face layer 14a. Face layer 14, fire-retarding attachment layer 16, reinforcing layer 18, fire-retarding attachment layer 16a, fluid-repelling layer 20, fluid-repelling layer 20a, fire-retarding attachment layer 16b, reinforcing layer 18a, and fire-retarding attachment layer 16c have been eliminated from the cross-sectional embodiment of FIG. 2. In other embodiments, any of the layers may vary in order or number, one or more of the layers may not be present, or one or more additional layers may be used. In still other embodiments, the fire-retarding apparatus 10 may consist of any combination of the layers including all of the layers or taking away one or more of the layers.

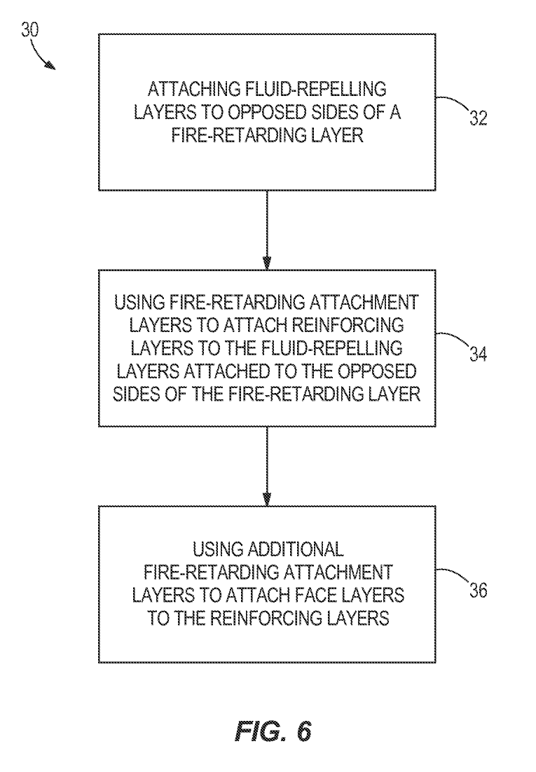

FIG. 6 is a flowchart illustrating one embodiment of a method 30 of manufacturing a fire-retarding apparatus comprising a composite. The method may be varied to manufacture any of the embodiments of the fire-retarding apparatus disclosed herein, or varied further to manufacturing varying fire-retarding apparatus having a varying combination of layers. In step 32, fluid-repelling layers may be attached to opposed sides of a fire-retarding layer. In step 34, fire-retarding attachment layers may be used to attach reinforcing layers to the fluid-repelling layers attached to the opposed sides of the fire-retarding layer. In other embodiments, any of the layers may be attached to one another through/using pressing, adhesives, tape, threads, screws, bolts, fasteners, rivets, staples, clamps, other mechanical members, or other attachment mechanisms. In still other embodiments, rather than attaching fire-retarding attachment layers, a reinforcing material may be embedded within the fire-retarding layer. In step 36, additional fire-retarding attachment layers may be used to attach face layers to the reinforcing layers. Optionally, fluid-repelling layers may be attached to the face layers.

In other embodiments, one or more steps of the method 30 may be varied in substance or in order, one or more steps of the method 30 may not be followed, or one or more additional steps may be added to the method 30. In still other embodiments, the method 30 may be used to manufacture a fire-retarding apparatus having any of the layers varied in order or number, having one or more of the layers not being present, or having one or more additional layers. In additional embodiments, the method 30 may be used to manufacture a fire-retarding apparatus consisting of any combination of the layers including all of the layers or taking away one or more of the layers.

One or more embodiments of the disclosure may allow for composite apparatus to be made fire-retarding while keeping the fire-retarding composite apparatus low-weight. This is a significant advantage in the airline industry where low weight leads to greater fuel efficiency thereby saving cost.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true scope of the subject matter described herein. Furthermore, it is to be understood that the disclosure is defined by the appended claims. Accordingly, the disclosure is not to be restricted except in light of the appended claims and their equivalents.

1. A fire-retarding apparatus comprising:
a composite comprising a face layer attached to a fire-retarding layer.

2. The fire-retarding apparatus of claim 1 wherein the face layer is non-fire-retarding.

3. The fire-retarding apparatus of claim 1 wherein the face layer comprises metal, non-metallic, composite, polyimide, or a fluid repellant coating.

4. The fire-retarding apparatus of claim 1 wherein the fire-retarding layer comprises metal, non-metallic, composite, ceramic, aerogel, xerogel, polyimide, mineral wool, (4,4-Oxydiphenylene-pyromellitmide), ceramic paste, ceramic coating, or an inorganic material.

5. The fire-retarding apparatus of claim 1 further comprising a fire-retarding attachment member or fire-retarding attachment layer attaching the face layer to the fire-retarding layer.

6. The fire-retarding apparatus of claim 5 wherein the fire-retarding attachment member or the fire-retarding attachment layer comprises pressed layers, adhesives, tape, fasteners, fire retarding clamps, fire retarding securement members, threads, screws, bolts, fasteners, rivets, clamps, or staples

7. The fire-retarding apparatus of claim 1 further comprising a second face layer, wherein the fire-retarding layer is attached between the face layer and the second face layer.

8. The fire-retarding apparatus of claim 1 further comprising a reinforcing layer attached to the fire-retarding layer.

9. The fire-retarding apparatus of claim 8 wherein the reinforcing layer comprises metal, non-metallic, composite, glass, ceramic, rubber, foam, Aramid, a solid material, a fibrous material, or a porous material.

10. The fire-retarding apparatus of claim 1 wherein the fire-retarding layer further comprises reinforcing material embedded in the fire-retarding layer.

11. The fire-retarding apparatus of claim 10 wherein the reinforcing material comprises metal, non-metallic, composite, glass, ceramic, rubber, foam, Aramid, a solid material, a fibrous material, or a porous material.

12. The fire-retarding apparatus of claim 1 further comprising a fluid-repelling layer attached to the face layer or the fire-retarding layer.

13. The fire-retarding apparatus of claim 12 wherein the fluid-repelling layer comprises silicone, or a nano-coating.

14. The fire-retarding apparatus of claim 1 wherein the fire-retarding apparatus weighs less than one pound per square foot and has a thickness of less than eight inches.

15. The fire-retarding apparatus of claim 1 wherein the fire-retarding apparatus comprises a portion of an aircraft, a portion of a spacecraft, or a portion of a vehicle.

16. A fire-retarding apparatus comprising:
a composite comprising a face layer, a fire-retarding layer, a fire-retarding attachment member or fire-retarding attachment layer attaching the face layer to the fire-retarding layer, and a reinforcing layer attached to the fire-retarding layer or reinforcing material embedded in the fire-retarding layer.

17. The fire-retarding apparatus of claim 16 wherein the composite further comprises a fluid-repelling layer attached to the face layer, the fire-retarding layer, or the reinforcing layer.

18. The fire-retarding apparatus of claim 16 wherein the fire-retarding apparatus weighs less than one pound per square foot and has a thickness of less than eight inches.

19. The fire-retarding apparatus of claim 16 wherein the fire-retarding apparatus comprises a portion of an aircraft, a portion of a spacecraft, or a portion of a vehicle.

20. A method of manufacturing a fire-retarding apparatus comprising:
attaching a fire-retarding layer to a face layer to form a composite.

21. The method of claim 20 further comprising attaching the fire-retarding layer to the face layer with a fire-retarding attachment member or with a fire-retarding attachment layer.

22. The method of claim 20 further comprising attaching the fire-retarding layer between the face layer and a second face layer.

23. The method of claim 20 further comprising attaching a reinforcing layer to the fire-retarding layer.

24. The method of claim 20 further comprising embedding a reinforcing material in the fire-retarding layer.

25. The method of claim 20 further comprising attaching a fluid-repelling layer to the face layer or to the fire-retarding layer.

26. The method of claim 20 further comprising the formed composite weighing less than one pound per square foot and having a thickness of less than eight inches.

27. The method of claim 20 further comprising the formed composite comprising a portion of an aircraft, a portion of a spacecraft, or a portion of a vehicle.
